(19) United States
(12) Patent Application Publication
(10) Pub. No.: US 2010/0253059 A1
(43) Pub. Date: Oct. 7, 2010

(54) Film Element for Protecting an Object

(75) Inventors: Achim Hansen, Zug (CH); Christina Streb, Abtwil (CH)

Correspondence Address: HOFFMANN & BARON, LLP, 6900 JERICHO TURNPIKE, SYOSSET, NY, 11791, US

(73) Assignee: OVD KINEGRAM AG, Zug (CH)

(21) Appl. No.: 12/740,034

(22) PCT Filed: Oct. 29, 2008
(86) PCT No.: PCT/EP2008/009120

§ 371 Date: Jun. 4, 2010

(30) Foreign Application Priority Data
Oct. 30, 2007 (DE) 102007052174.1-45

(51) Int. Cl. B42D 15/10; B32B 3/30; B32B 3/02

(52) U.S. Cl. 283/75; 428/156; 428/157; 283/57

(57) ABSTRACT

The invention relates to a film element for protecting an object, in particular a valuable document, a data carrier or a product, wherein the film element has a diffractive relief structure which produces an optically variable effect, wherein the film element has, when viewed perpendicularly to the film plane, a basic shape having a contour, wherein recesses in the form of a pattern are provided in the region of at least 25% of the contour of the basic shape at the circumference of the film element, which recesses form an information item which is superposed on the basic shape and provide the circumference of the film element with notches.

The invention relates to a film element for protecting an object, in particular a valuable document, a data carrier or a product, wherein the film element has a diffractive relief structure which produces an optically variable effect. The invention furthermore relates to an object which is protected by at least one such film element.

Such transparent film elements and their use for protecting objects such as identity passes are sufficiently known. JP 05201182 A describes laminated cards which are provided with printed information or images on one side, wherein a transparent film element covers the printed information or images and is adhesively bonded to the card. The film element protects the printed information or images against unauthorized manipulations.

In this case, film elements can in principle be formed either by self-supporting lamination films which can be laminated onto an object or by a thin non-self-supporting transfer layer of a transfer film which is transferred usually by means of embossing onto the object. A transfer film has a carrier film and, thereon, the non-self-supporting transfer layer which can be detached from the carrier film. The transfer film is pressed against the object by means of an embossing tool, wherein a region of the transfer layer is left behind stuck to the object. When the carrier film is peeled off the object to be protected, the pressed-on region of the transfer layer remains stuck to the object and forms a thin film element, typically having a film thickness in the range of 3 to 25 μm. A laminating film has, by comparison, a significantly greater film thickness, typically in the range of 15 to 250 μm.

The optically variable effect, which is produced by the diffractive relief structure, can take the form, on the film element, of a viewing angle-dependent color change effect and/or contrast change and/or motive change, a formation of a holographic or cinematographic representation and so on.

The film element is in this case configured in a specific basic shape, which is determined, in the case of the use of a transfer film, for example by the contour shape of the transfer film or of the transfer layer, the contour shape and/or patterning of the embossing tool used or the arrangement of an adhesive layer, which is positioned between the object and the transfer layer, for fixing regions of the transfer layer to an object. In the case of the laminating film, the basic shape is given by the former, specifically its contour. In the case of the laminating film, an adhesive layer for fixing is again provided for fixing the former to the object. Usually, a round or rectangular basic shape is selected for the film element. DE 39 32 505 A1 already describes film elements which can have a contour shape in the form of image symbols, letters and so on.

However, it has been shown that the known film elements can be imitated or can, under certain circumstances, be separated from the object which is protected by them, for example by means of transparent adhesive films, without damaging the film element, in order to manipulate information data on the object or to completely exchange the object.

By way of example, the transparent adhesive film is adhesively bonded over film elements, which are peeled off the object at least to an extent such that the information data can be manipulated or a thin sheet with the desired information data can be inserted between the film element and the object which is protected by it. Subsequently, the composite between the object and the film element is restored, wherein the transparent film typically remains on the film element.

Alternatively, the transparent adhesive film is adhesively bonded by way of example on top of the film element, and the carrier substrate of an original object is ground off starting from its rear side in order to obtain the original film element which is adhesively bonded to the front side. Subsequently, the adhesive film is cut to the size of the original film element and the film element is applied to a different object which is not original.

This is possible not only in the case of film elements which have basic shapes with simple contours, such as circles, rectangles and so on, but also in the case of film elements with more complex contours, as are already described in DE 39 32 505 A1.

It is now an object of the invention to provide a film element which renders manipulation of an object which is protected by it or imitation more difficult.

The object is achieved by a film element for protecting an object, in particular a valuable document, a data carrier or a product, wherein the film element has a diffractive relief structure which produces an optically variable effect, wherein the film element has, when viewed perpendicularly to the film plane, a basic shape having a contour, by way of recesses in the form of a pattern being provided in the region of at least 25% of the contour of the basic shape in the region of the circumference of the film element, which recesses form an information item which is superposed on the basic shape and provide the film element in the region of the circumference with notches.

A notch is an acutely or substantially acutely tapered indent or acutely or substantially acutely tapered film portion in the region of the circumference of the film element, which promotes, when attempting detachment of the film element from the object to be protected, the formation of tears and their propagation transversally through regions of the film element, with the result that detachment of the film element in one piece, i.e. without sustaining any damage, is prevented or at least made more difficult. The indent or film portion (or the longitudinal axis thereof) is preferably aligned in the film plane perpendicularly toward the circumference of the film element, but can also be arranged at an angle thereto. The end of a notch can be pointed or slightly flattened, wherein the end can face away from the film element or toward the film element. Depending on the basic shape of the film element, an arrangement and alignment of the notches is selected, which are very likely to lead to a formation of tears in the film element when an attempt is made to detach the film element without authorization. In this case, a notch can enlarge the circumference of the film element or be arranged such that it is enclosed on all sides by the film element. For example, a notch which is enclosed on all sides by the film element can be provided by removing V-shaped or W-shaped parts in the film element, wherein the V-shaped or W-shaped opening which is formed is spaced apart from the circumference of the film element.

In addition to notches, the recesses which are in the form of a pattern preferably have further openings which form, for example, holes or patterns with rounded edges, which do not necessarily have to promote further a formation of tears. Such openings are used preferably in combination with the notches for the formation of the information item.

The recesses which are in the form of a pattern form, in particular, narrow and/or acutely tapered film regions or film webs at the circumference of the film element, which easily tear or stretch excessively under mechanical stress, such as when an attempt is made to detach the film element without authorization, and thus show visible damage. In particular, the recesses which are in the form of a pattern are used to form narrow film regions with a width in the range of 0.3 to 5 mm.

Imitation of film elements which have such recesses which are in the form of a pattern is possible only with the aid of complex systems engineering. The recesses which are in the form of a pattern at the circumference of the film element form a readable and checkable information item and effectively prevent, owing to their groove effect in the region of the circumference of the film element, the unauthorized detachment of a complete, undamaged film element. The film element can also no longer be detached successfully using a transparent adhesive film since the adhesive film would have to be tailored according to the recesses which are in the form of a pattern. Due to the specially designed edge of the film element, the carrier substrate cannot be ground off starting from the rear side of the object without damaging the edge.

It is particularly preferred if the recesses which are in the form of a pattern are provided in the region of at least 40%, further preferred of at least 50%, in particular of at least 75% of the contour of the basic shape in the region of the circumference of the film element. The arrangement of the recesses which are in the form of a pattern is preferably chosen here such that detachment of the film element, starting from any desired point at the circumference of the film element, is highly likely to result in the formation of tears and damage to the film element.

It has proven useful if the recesses which are in the form of a pattern per centimeter of contour of the basic shape form at least one notch, preferably at least two notches, in the region of the circumference of the film element. Preferably, between one and ten, further preferred between one and five notches, per centimeter of contour of the basic shape are formed by the recesses which are in the form of a pattern. Particularly efficient protection of the film element against detachment or against imitation is thus ensured.

The depth-to-width ratio of the recesses which are in the form of a pattern is preferably greater than 0.3, further preferred greater than 0.75. The depth-to-width ratio of the recesses which are in the form of a pattern is preferably in the range of 0.3 to 2.5, further preferred in the range of 0.7 to 1.5. “Depth-to-width ratio” of the recesses which are in the form of a pattern refers to the ratio of the depth of the notch, i.e. the spacing between the in this sense deepest point of the recess which is in the form of a pattern and its projection onto the straight line connecting the two points of intersection mentioned above, to the width of the respective recess which is in the form of a pattern at its base, i.e. the distance between the points of intersection with the contour line of the basic shape.

The depth of the notches is preferably between 1 and 10 mm, preferably between 1 and 6 mm.

It is preferred if the recesses which are in the form of a pattern and thus also the information items repeat themselves at least five times, in particular at least ten times, along the circumference of the film element. Such repetitive patterns are particularly memorable for the viewer of the film element, while being difficult to imitate.

The information item preferably comprises at least a symbol and/or a logo and/or an alphanumeric character and/or lettering and/or a sequence of numbers and/or a graphic pattern and/or an image-type representation or figurative representation and/or a code such as a barcode. A recess which is in the form of a pattern and in the form of a C= sign, which appears repeatedly at the circumference of the film element, if appropriate in varying sizes, can be selected as a symbol, for example, for a film element. Alphanumeric characters can be used individually or can be placed one next to the other in order to form lettering, a sequence of numbers, a brand name, a technical or chemical formula and so on. An image-type representation comprises in particular figurative representations, representations from the fields of flora and fauna, architecture, astronomy, sport, technology, and so on.

It has proven useful if the recesses which are in the form of a pattern are visible at least partially with the naked human eye. This enables a quick and uncomplicated check of the film element without any technical aids. However, it is likewise advantageous if the recesses which are in the form of a pattern are at least partially invisible to the naked human eye with the result that they can be discerned only using a magnifying glass, for example. Such fine recesses can be imitated only with great effort and usually require the use of cost-intensive laser technology. A combination of recesses which are in the form of a pattern and can be discerned with the naked human eye and those which cannot be discerned with the naked human eye is ideal.

Recesses which are in the form of a pattern can primarily be seen with the naked human eye if the recesses which are in the form of a pattern have at most ten notches per centimeter of contour of the basic shape. Recesses which are in the form of a pattern are primarily at least partially invisible to the naked human eye if they have, per centimeter of contour of the basic shape, more than ten notches per centimeter of contour of the basic shape, form preferably 20 or more notches per centimeter of contour of the basic shape. Such recesses, however, preferably have less than 100, further preferred less than 50 notches per centimeter of contour of the basic shape.

As already discussed above, it is also possible in this case to provide both recesses which are in the form of a pattern and can be discerned with the naked human eye and those which cannot be discerned with the naked human eye. In this case, it is not only possible for these recesses to be provided one next to another at the circumference of the film element, but it is also possible that such recesses superpose one another and thus recesses which are in the form of a pattern are provided in at least one partial region of the circumference of the film element, which recesses consists of superposition of a macrostructure, which describes recesses which are discernable with the naked human eye, and a microstructure, which describes recesses which are in the form of a pattern and are at least partially invisible to the naked human eye.

These two types of recesses preferably have the above-described depth-to-width ratio.

In this manner, the information item superposing the basic shape can provide a first information item which is discernable with the naked human eye and a second information item which is discernable only using an aid (magnifying glass).

The recesses which are in the form of a pattern are preferably located in an edge strip of the film element, which edge strip has, when viewed perpendicularly to the film plane, a width in the range of 0.5 to 10 mm, in particular of 2 to 5 mm. The width of the edge strip can in this case be kept constant over the circumference of the film element, or can vary by section, in which case the change can be sudden or continuous. Sudden changes are in this case particularly suitable for further increasing the groove effect of the notches, whereas continuous changes, for example having an undulating characteristic, are difficult to imitate. Both embodiments are preferably used for the film element, by way of providing a sudden change in a first region of its circumference and a continuous change in a second region of its circumference.

It has proven useful if the contour of the basic shape represents a circle, an ellipse, a rectangle, a triangle, a star, a figurative or image-type representation, a symbol, a logo or an alphanumeric character. The basic shape is in this case dimensioned in particular to be greater than an information item formed by the recesses which are in the form of a pattern by a factor of 10 to 1000. Here, the basic shape and the information item formed by the recesses which are in the form of a pattern, in particular also the optically variable effect, can be matched to one another in terms of a theme. By way of example, the basic shape can be that of a C= sign character and the recesses which are in the form of a pattern can likewise form a number of C= sign characters, which, however, are dimensioned to be smaller by a factor 2 to 3.

Alternatively, the basic shape can show the contour of a portrait of a famous person, the optically variable effect shows a holographic representation of the portrait of this person, and the recesses which are in the form of a pattern form, as the information item, the name of the person in form of lettering, which is dimensioned to be smaller by a factor 2 to 5 than the basic shape.

It has proven useful if the film element comprises at least one adhesive layer, at least one reflection layer and at least one transparent plastics or lacquer layer, wherein the diffractive relief structure is formed into a side of the at least one plastics or lacquer layer which faces the at least one reflection layer.

Alternatively, the film element can also comprise only an adhesive layer and at least one transparent plastics or lacquer layer, wherein the adhesive layer is arranged on that side of the plastics or lacquer layer which faces away from the diffractive relief structure. In this case, the diffractive relief structure does not adjoin a reflection layer which is applied on the plastics or lacquer layer, but rather adjoins air, wherein the air acts like a reflection layer, as long as the difference between the refractive index of the air and that of the plastics or lacquer layer is sufficiently large.

Further layers which are already sufficiently known in the field of security elements, the printing ink layers, magnetic layers, luminescent layers, liquid crystal layers, photochromic layers, adhesion-promoter layers and so on, can be contained in the film element.

The diffractive relief structure preferably is introduced into the at least one transparent plastics or lacquer layer by thermal replication or UV replication. In this case, an embossing punch or an embossing roller with a surface relief is pressed against the transparent plastics or lacquer layer and the diffractive relief structure is formed thereon.

The reflection layer can be opaque, semi-transparent or transparent. The reflection layer can also be only partially formed. Layers which have proven suitable for forming opaque, semi-transparent or transparent reflection layers are metallic layers, for example of aluminum, silver, gold, copper, nickel and so on, which are opaque or transparent, depending on the layer thickness. Transparent reflection layers are alternatively formed by dielectric layers, for example of ZnS, ZnO, SiO₂, TiO₂ and so on.

The film element itself can be opaque, partially transparent or transparent. In order to form a transparent film element or a film element which is transparent at least in partial regions, use is made of at least one transparent reflection layer and/or at least one opaque reflection layer which is only partially formed. Furthermore, the adhesive layer and, if appropriate, any other layers present must be transparent in order to form a transparent film element or a film element which is transparent at least in partial regions.

The film element preferably has a film thickness in the region of 3 to 25 μm. Such thin film elements are non-self-supporting and are typically transferred onto an object by means of the transfer film technique described above. Thin film elements are particularly susceptible to breakage and difficult to detach. But even thicker, self-supporting film elements having a thickness in the range of 15 to 250 μm, which are in the form of a laminating film or a sticker, can be used as an alternative.

It is an advantage if the diffractive relief structure is formed at least in those regions of the film element that are adjacent to the recesses which are in the form of a pattern, with the result that the optically variable effect is produced at least in those regions of the film element that are adjacent to the recesses which are in the form of a pattern. This increases the visual recognizability of the information produced by the recesses which are in the form of a pattern. However, it is particularly preferred if the diffractive relief structure is present as a large area and the optically variable effect which is generated is visible to the viewer in all regions of the film element.

The film element preferably has additionally on that side which faces the viewer when the film element is fixed to the object a further relief structure at least in regions. A further relief structure of this kind is in particular in the form of a macroscopic and/or microscopic relief structure. The further relief structure is preferably visually and/or haptically detectable. The further relief structure can here form a pattern, a guilloche structure, a lens structure, a matt structure, a diffractive structure and so on or a combination thereof.

Protecting an object, in particular a valuable document, a data carrier or a product, having a carrier substrate and in particular information data which are printed thereon, with at least one film element according to the invention, which film element is fixed to the carrier substrate, is ideal.

For protecting the object, preferably a transparent or regionally transparent film element is used which covers at least some of the information data, wherein the covered information data remain readable.

After fixing the film element to the object, a transparent protective film can, if appropriate, be arranged over the film element, which protective film covers the film element and at least partially also regions of the object which are free therefrom. However, it needs to be ensured in this case that, in an unauthorized attempt to detach the film element from the object using a transparent adhesive film, the film element cannot be removed, or at least not without damage, together with the protective film.

If the object is a valuable document, it is preferably a banknote, an identity card, a passport, an identity pass, a bank card, a travel ticket, a driver's license, a certificate, a reference, a bond, a lottery ticket or the like. If the object is a data carrier, it is preferably a DVD, a CD, a disc, a film reel, a memory chip, a label or the like.

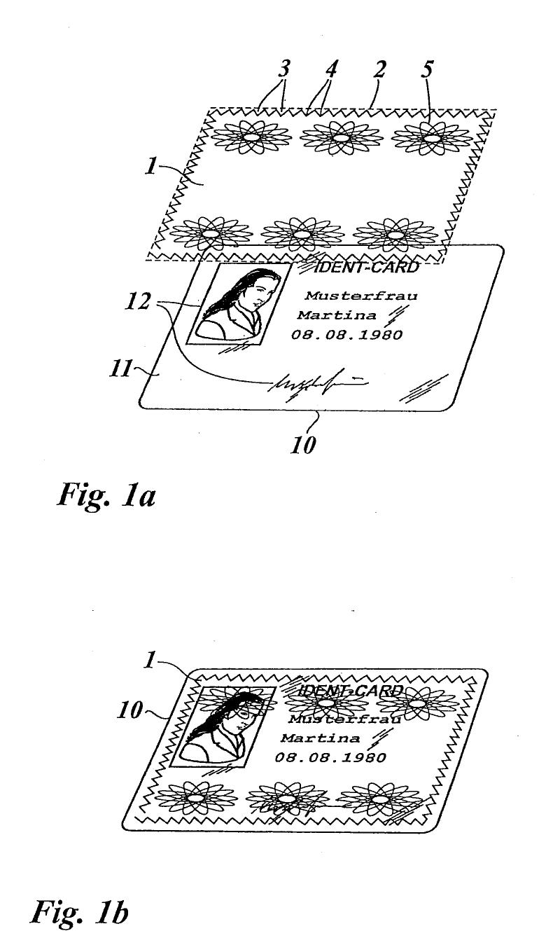

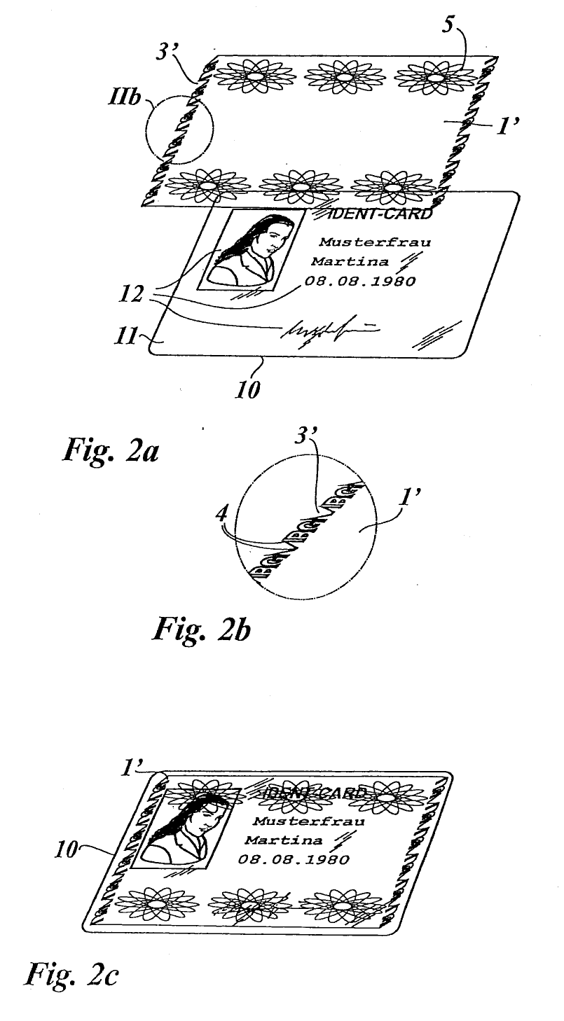

FIGS. 1a to 2c are meant to illustrate in an exemplary fashion the film element according to the invention. In the figures,

FIG. 1a shows a first film element for protecting an identity card in three-dimensional representation,

FIG. 1b shows an identity card with a film element according to FIG. 1a,

FIG. 2a shows a second film element for protecting an identity card in three-dimensional representation,

FIG. 2b shows an enlargement of a detail at the edge of the second film element,

FIG. 2c shows an identity card with a second film element according to FIG. 2a.

FIG. 1a shows a three-dimensional representation of a first film element 1 for protecting an object 10 in the form of an identity card. The object 10 has a carrier substrate 11 and information data 12 printed thereon, which information data 12 display personal data of the identity card holder and her picture and other details specific to the present identity card. The film element 1 is transparent and has a basic shape 2 with a rectangular contour, wherein the film element 1 is dimensioned to be slightly smaller than the carrier substrate 11. The contour of the basic shape 2 is provided with recesses 3 which are in the form of a pattern in the form of notches which produce a zigzag-shaped profile of the contour of the film element 1 and enlarge the circumference of the film element 1 with respect to the rectangular contour of its basic shape 2. The circumference of the film element 1 contacts the contour of the basic shape 2 only in points now, due to the recesses 3 which are in the form of a pattern. The recesses 3 which are in the form of a pattern are here provided in the region of 100% of the contour of the basic shape 2 at the circumference of the film element 1. The film element 1 has, on its entire surface, an optically variable effect 5 which is generated by a diffractive relief structure. The film element 1 is adhesively bonded to the carrier substrate 11 such that it covers the information data 12 printed thereon.

FIG. 1b shows the finished identity card with the object 10 and the first film element 1 which is adhesively bonded thereto according to FIG. 1a, wherein the film element 1 is provided on its side which faces away from the object 10 with a visually and/or haptically detectable relief structure (not illustrated here).

FIG. 2a shows a three-dimensional representation of a second film element 1′ for protecting an object 10 in the form of an identity card. The object 10 has a carrier substrate 11 and information data 12 printed thereon, which information data 12 display personal data of the identity card holder and her picture and other details specific to the present identity card. The film element 1′ is transparent and has a basic shape with a rectangular contour, wherein the film element 1′ is dimensioned to be slightly smaller than the carrier substrate 11. The contour of the basic shape is provided with recesses 3′ which are in the form of a pattern in the form of notches which produce a pattern-type profile, containing the letters “B” and “G” and “M”, of the contour of the film element 1′ (see enlarged detail 2b of the circumference of the film element 1′ in FIG. 2b) and enlarge the circumference of the film element 1′ with respect to the rectangular contour of its basic shape. The circumference of the film element 1′ contacts the contour of the basic shape at the short sides only in regions now, due to the recesses 3′ which are in the form of a pattern. The recesses 3′ which are in the form of a pattern are here provided in the region of less than 50% of the contour of the basic shape at the circumference of the film element 1′. The film element 1′ has, on its entire surface, an optically variable effect 5 which is generated by a diffractive relief structure. The film element 1′ is adhesively bonded to the carrier substrate 11 such that it covers the information data 12 printed thereon.

FIG. 2b shows an enlargement of the detail 2b of the film element 1′ from FIG. 2a, in which the provided notches 4′ can be seen in detail.

FIG. 2c shows the finished identity card with the object 10 and the first film element 1′ which is adhesively bonded thereto according to FIG. 2a.

The film element can have a multiplicity of further recesses (not shown in detail) which are in the form of a pattern in the region of its circumference, which provide readable information and at the same time exhibit a groove effect.

1. A film element for protecting a valuable document, a data carrier or a product, wherein the film element has a diffractive relief structure which produces an optically variable effect, wherein the film element has, when viewed perpendicularly to the film plane, a basic shape having a contour, wherein recesses in the form of a pattern are provided in the region of at least 25% of the contour of the basic shape at the circumference of the film element, which recesses form an information item which is superposed on the basic shape and provide the circumference of the film element with notches.

2. The film element as claimed in claim 1, wherein the recesses which are in the form of a pattern are provided in the region of at least 75% of the contour of the basic shape at the circumference of the film element.

3. The film element as claimed in claim 1, wherein the recesses which are in the form of a pattern per centimeter of contour of the basic shape form at least one notch in the circumference of the film element.

4. The film element as claimed in claim 1, wherein the recesses which are in the form of a pattern and thus also the information items repeat themselves at least ten times, along the circumference of the film element.

5. The film element as claimed in claim 1, wherein the information item comprises at least a symbol and/or a logo and/or an alphanumeric character and/or lettering and/or a sequence of numbers and/or a graphic pattern and/or an image-type representation or figurative representation and/or a code.

6. The film element as claimed in claim 1, wherein the recesses which are in the form of a pattern are visible at least partially with the naked human eye.

7. The film element as claimed in claim 1, wherein the recesses which are in the form of a pattern are invisible at least partially with the naked human eye.

8. The film element as claimed in claim 1, wherein the recesses which are in the form of a pattern are located in an edge strip of the film element, which edge strip has, when viewed perpendicularly to the film plane, a width in the range of 2 to 10 mm.

9. The film element as claimed in claim 1, wherein the contour of the basic shape represents a circle, an ellipse, a rectangle, a triangle, a star, a figurative or image-type representation, a symbol, a logo or an alphanumeric character.

10. The film element as claimed in claim 1, wherein the basic shape is dimensioned to be greater than the information item which is superposed on the basic shape by a factor of 10 to 1000.

11. The film element as claimed in claim 1, wherein the film element comprises at least one adhesive layer, at least one reflection layer and at least one transparent plastics or lacquer layer, wherein the diffractive relief structure is formed into a side of the at least one plastics or lacquer layer which faces the at least one reflection layer.

12. The film element as claimed in claim 1, wherein the film element has a film thickness in the range of 3 to 250 μm.

13. The film element as claimed in claim 1, wherein the film element is opaque or partially transparent or transparent.

14. The film element as claimed in claim 1, wherein the diffractive relief structure is formed at least in those regions of the film element that are adjacent to the recesses which are in the form of a pattern, with the result that the optically variable effect is produced at least in those regions of the film element that are adjacent to the recesses which are in the form of a pattern.

15. The film element as claimed in claim 1, wherein the film element has on its side that is to be arranged such that it faces away from the object a further relief structure at least in regions.

16. An object having a carrier substrate and information data which are printed thereon, wherein at least one film element as claimed in claim 1 is fixed to the carrier substrate.

17. The object as claimed in claim 16, wherein the at least one film element is transparent and covers at least part of the information data.

18. The object as claimed in claim 16, wherein the object is a valuable document in the form of a banknote, an identity card, a passport, an identity pass, a bank card, a travel ticket, a driver's license, a certificate, a reference, a bond or a lottery ticket.

19. The object as claimed in claim 16, wherein the object is a data carrier in the form of a DVD, a CD, a disc, a film reel, a memory chip or a label.
